(19) United States
(12) Patent Application Publication
(10) Pub. No.: US 2011/0243432 A1
(43) Pub. Date: Oct. 6, 2011

(54) Determining the Scale of Images

(75) Inventor: Daniel O. Hirsch, Jr., Springfield, MO (US)

(73) Assignee: McKesson Financial Holdings Limited

(21) Appl. No.: 12/749,908

(22) Filed: Mar. 30, 2010

(51) Int. Cl. G06K 9/00

(52) U.S. Cl. 382/165

(57) ABSTRACT

Systems, methods, apparatus, and computer program products are provided for determining the scale of an image. In one embodiment, an image is received for analysis. The image may include a token with (a) a known height, (b) a known width, and (c) a known color value based on a color model. Pixels that are within a predetermined threshold of the known color value of the image are identified. After identifying the pixels, a cluster of pixels that substantially includes the token is identified. With the known size of the token and the pixels in the token identified, the scale of the image can be determined.

### BACKGROUND

In various situations, it may be advantageous to determine the scale of an image (e.g., a photograph). For example, in clinical environments, a wound may be measured by physically placing a small ruler proximate the wound and estimating the size of the wound. If, however, an image of the wound were taken and the scale of the image known, precise measurements of the wound could be determined. Thus, for a variety of uses, a need exits for determining the scale of images.

### BRIEF SUMMARY

In general, embodiments of the present invention provide systems, methods, apparatus, and computer program products for determining the scale of an image.

According to one aspect, a computer-implemented method for determining the scale of an image is provided. In one embodiment, the computer-implemented method comprises (1) receiving an image for analysis, wherein the image comprises a token with (a) a known height, (b) a known width, and (c) a known color value based on a color model; (2) identifying a predetermined threshold, wherein the predetermined threshold provides a range of color values that have a substantially similar color value as the known color value of the token; (3) identifying a plurality of pixels in the image that are within the predetermined threshold; (4) identifying a cluster of pixels from the plurality of pixels, wherein the cluster of pixels substantially comprises the token; and (5) determining a scale of the image based at least in part on (a) the known height and the known width of the token and (b) the cluster of pixels.

In accordance with another aspect, a computer program product for determining the scale of an image is provided. The computer program product may comprise at least one computer-readable storage medium having computer-readable program code portions stored therein, the computer-readable program code portions comprising executable portions configured to (1) receive an image for analysis, wherein the image comprises a token with (a) a known height, (b) a known width, and (c) a known color value based on a color model; (2) identify a predetermined threshold, wherein the predetermined threshold provides a range of color values that have a substantially similar color value as the known color value of the token; (3) identify a plurality of pixels in the image that are within the predetermined threshold; (4) identify a cluster of pixels from the plurality of pixels, wherein the cluster of pixels substantially comprises the token; and (5) determine a scale of the image based at least in part on (a) the known height and the known width of the token and (b) the cluster of pixels.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an exemplary schematic diagram of a computing device according to one embodiment of the present invention.

FIGS. 2A, 2B, and 3 show images comprising exemplary tokens according to certain embodiments of the present invention.

FIG. 4 is a flowchart illustrating operations and processes that can be used in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. Like numbers refer to like elements throughout.

### I. METHODS, APPARATUS, SYSTEMS, AND COMPUTER PROGRAM PRODUCTS

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. EXEMPLARY SYSTEM ARCHITECTURE

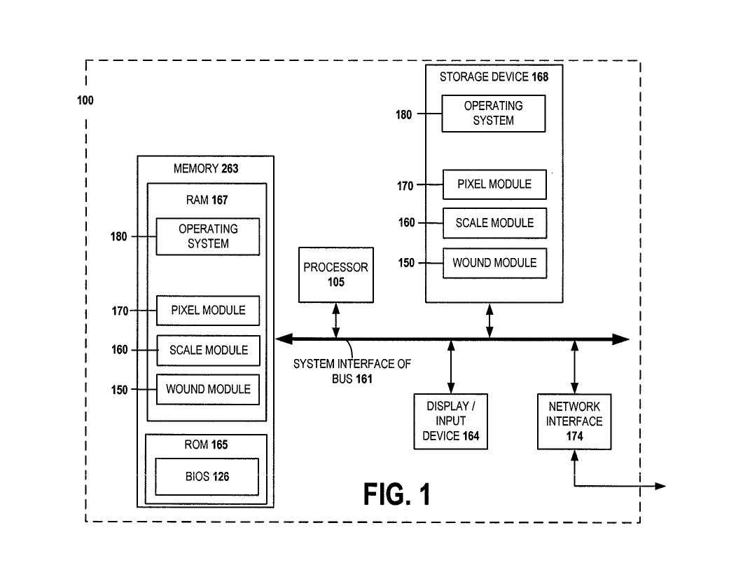

FIG. 1 provides a schematic of a computing device 100 according to one embodiment of the present invention. In general, the term “computing device” may refer to, for example, any computer, desktop, notebook or laptop, distributed system, server, gateway, switch, or other processing device adapted to perform the functions described herein. As will be understood from this figure, in this embodiment, the computing device 100 includes a processor 105 that communicates with other elements within the scheduling system 100 via a system interface or bus 161. The processor 105 may be embodied in a number of different ways. For example, the processor 105 may be embodied as various processing means such as a processing element, a coprocessor, a controller or various other processing devices including integrated circuits such as, for example, an application specific integrated circuit (“ASIC”), a field programmable gate array (“FPGA”), a hardware accelerator, or the like.

In an exemplary embodiment, the processor 105 may be configured to execute instructions stored in the device memory or otherwise accessible to the processor 105. As such, whether configured by hardware or software methods, or by a combination thereof, the processor 105 may represent an entity capable of performing operations according to embodiments of the present invention while configured accordingly. A display device/input device 164 for receiving and displaying data is also included in the computing device 100. This display device/input device 164 may be, for example, a keyboard or pointing device that is used in combination with a monitor. The computing device 100 further includes memory 163, which may include both read only memory (“ROM”) 165 and random access memory (“RAM”) 167. The computing device's ROM 165 may be used to store a basic input/output system (“BIOS”) 126 containing the basic routines that help to transfer information to the different elements within the computing device 100.

In addition, in one embodiment, the computing device 100 includes at least one storage device 168, such as a hard disk drive, a CD drive, and/or an optical disk drive for storing information on various computer-readable media. The storage device(s) 168 and its associated computer-readable media may provide nonvolatile storage. The computer-readable media described above could be replaced by any other type of computer-readable media, such as embedded or removable multimedia memory cards (“MMCs”), secure digital (“SD”) memory cards, Memory Sticks, electrically erasable programmable read-only memory (“EEPROM”), flash memory, hard disk, or the like. Additionally, each of these storage devices 168 may be connected to the system bus 161 by an appropriate interface.

Furthermore, a number of program modules may be stored by the various storage devices 168 and/or within RAM 167. Such program modules may include an operating system 180, pixel module 170, a scale module 160, and a wound module 150. These modules may control certain aspects of the operation of the computing device 100 with the assistance of the processor 105 and operating system 180—although their functionality need not be modularized. In addition to the program modules, the computing device 100 may store or be connected to one or more databases with one or more tables stored therein.

Also located within the computing device 100, in one embodiment, is a network interface 174 for interfacing with various computing entities. This communication may be via the same or different wired or wireless networks (or a combination of wired and wireless networks), as discussed above. For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the computing device 100 may be configured to communicate via wireless external communication networks using any of a variety of protocols, such as 802.11, general packet radio service (“GPRS”), wideband code division multiple access (“W-CDMA”), or any other wireless protocol.

It will be appreciated that one or more of the computing device's 100 components may be located remotely from other computing device 100 components. Furthermore, one or more of the components may be combined and additional components performing functions described herein may be included in the computing device 100.

### III. EXEMPLARY SYSTEM OPERATION

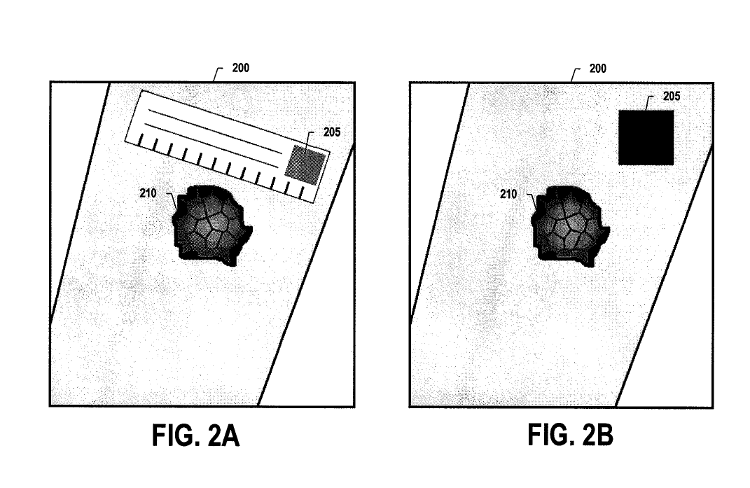

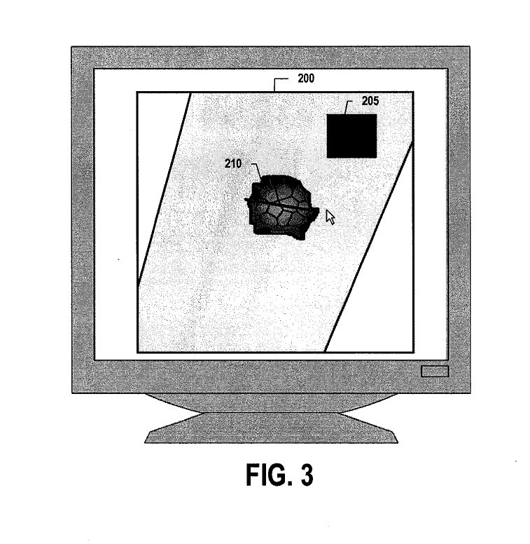

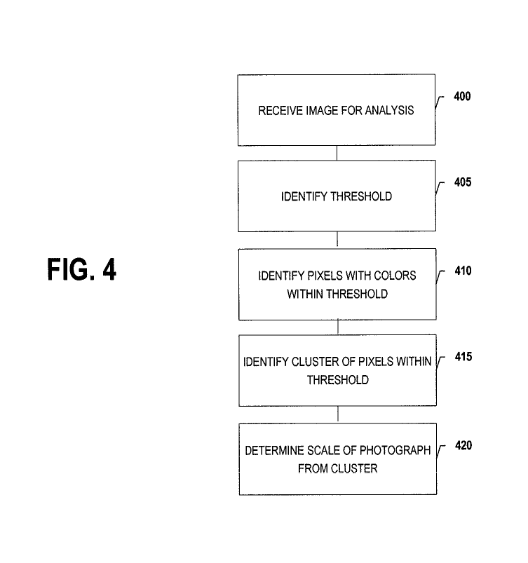

Reference will now be made to FIGS. 2A, 2B, and 3-4. FIGS. 2A, 2B, and 3 show images comprising exemplary tokens according to certain embodiments of the present invention. FIG. 4 illustrates operations and processes that can be performed to determine the scale of an image.

a. Images and Tokens

In one embodiment, as shown in FIG. 4, the process begins by the computing device 100 receiving an image 200 for analysis (Block 400). The image 200 may be a digital image in a particular digital image format, such as a Joint Photographic Experts Group (“JPEG”) format, a bitmap (“BMP”) format, a Graphics Interchange Format (“GIF”), a Portable Network Graphics (“PNG”) format, a Tagged Image File Format (“TIFF”), or any of a variety of other digital image formats.

The image 200 may also include certain features. For example, in one embodiment, the image 200 may include a token 205. As shown in FIGS. 2A, 2B, and 3, the token 205 may be an article (e.g., a piece of paper, plastic, or metal) placed proximate a wound that was photographed. In other embodiments (not shown), the token 205 may be an object in the image 200, such as a sign, building, window, or other object included in the image 200. The token 205 may be any of a variety of shapes, such as a rectangle, a trapezoid, or a square. In a particular embodiment, the token 205 is a square because the height and width of a square are the same. In various embodiments, the token 205 being a square allows the token 205 and the image 200 to be easily righted and deskewed. In addition to the token 205 being a square, in one embodiment, the token 205 has (a) a known height and (b) a known width. For example, the known height and known width of the token 205 may be 18 millimeters, 2 centimeters, 3 inches, and/or the like. It should be noted that a variety of sizes and shapes of tokens 205 can be used to adapt to various needs and desires.

In one embodiment, the token 205 has a known color value (e.g., color) based on a color model. The color model may be the (a) red, green, blue color model (“RGB color model”), (b) cyan, magenta, yellow, and key black color model (“CMYK color model”), or (c) any other color model. In a particular embodiment, the token 205 has a known color value based on the RGB color model. Illustrative parameters used in the RGB color model are shown below in Table 1.

TABLE 1

| | |
|---|---|
| Red | An integer in the range 0-255 that represents the red component |
| | of the color. |
| Green | An integer in the range 0-255 that represents the green |
| | component of the color. |
| Blue | An integer in the range 0-255 that represents the blue component |
| | of the color. |

In one embodiment, the known color value of the token 205 corresponds to a high-contrast color, such as a color that would contrast with most of the colors in the image 200. In various embodiments, color values corresponding to the least frequently found colors in the natural world may be used for the token 205. By using such infrequently used color values (e.g., colors) in the token 205, the token 205 may be more effectively identified in the image 200 by the computing device 100. In one embodiment, the known color value of the token 205 corresponds to a pure blue color with an RGB color value of (a) 0, 0, 255 or (b) 0000FF. In another embodiment, the known color value of the token 205 corresponds to a pure green color with an RGB color value of (a) 0, 255, 0 or (b) 00FF00. A variety of color values (e.g., colors) of tokens 205 can be used to adapt to various needs and desires.

b. Identifying the Token

In one embodiment, after receiving the image 200 with (a) a known height, (b) a known width, and (c) a known color value based on a color model, the computing device 100 identifies the token 200 in the image 200. More specifically, the computing device 100 identifies pixels that comprise the token 205 in the image 200 (e.g., via the pixel module 170). To do so, in one embodiment, the computing device 100 first identifies a predetermined threshold (Block 405), e.g., a threshold set by a user of the computing device 100 or automatically determined by the computing device 100. The predetermined threshold may be used, for example, to identify pixels with color values within a certain percentage of the known color value of the token 205. For example, in one embodiment, the threshold comprises any color value (e.g., on the bit level) within the Euclidean distance of 20 from the known color value of the token 205. Thus, using this particular predetermined threshold, any pixel with a color value within the Euclidean distance of 20 from the known color value of the token 205 would be identified as a pixel for reinvestigation. The Euclidean distance may be changed based on, for example, the known color value of the token 205 and/or a variety of other factors. Moreover, a variety of other techniques and approaches can be used for the predetermined threshold.

In one embodiment, after identifying the predetermined threshold, the computing device 100 identifies pixels (e.g., a plurality of pixels) in the image 200 that are within the predetermined threshold (Block 410). For example, the computing device 100 may spin through the image 200 array and search for color values that are within the predetermined threshold (e.g., within a certain percentage of the known color value of the token 205). In one embodiment, this is accomplished by the computing device 100 evaluating the color value of each pixel individually. Thus, if the computing device 100 determines that a given pixel is within the Euclidean distance of 20 from the known color value of the token 205, the pixel is identified as a pixel for reinvestigation (e.g., along with its corresponding coordinates). Accordingly, each pixel of the image 200 with a color value within the predetermined threshold is identified as pixel for reinvestigation (e.g., identified as a pixel that may comprise part of the token 205).

After evaluating each pixel and identifying the pixels that are within the predetermined threshold for reinvestigation, the computing device 100 identifies the token 205 from among the pixels identified for reinvestigation. For example, in one embodiment, using the coordinates of the pixels identified for reinvestigation, the computing device 100 identifies a cluster of pixels from among the pixels identified for reinvestigation (Block 415). Because the color values of the pixels identified for reinvestigation are likely uncommon colors (e.g., high-contrast colors like pure blue (0, 0, 255) or pure green (0, 255, 0), the cluster of pixels likely comprise the token 205. A variety of other techniques and approaches can be used to identify the cluster of pixels comprising the token 205.

c. Determining the Scale of the Image

In one embodiment, once the computing device 100 identifies the cluster of pixels comprising the token 205, the computing device 100 determines the dimensions of the image 200 (Block 420). To determine the dimensions of the image 200 (e.g., via the scale module 160), a variety of approaches and techniques may be used.

### 1. Enumerating Pixels in the Cluster

In one embodiment, to determine the scale of the image 200, the computing device 100 determines (e.g., enumerates/counts) the number of pixels in the cluster of pixels. After determining the number of pixels in the cluster, the computing device 100 can determine (a) the number of pixels per unit of measurement and/or (b) the unit of measurement per pixel in the image 200. For example, to determine the number of pixels per unit of measurement, the computing device 100 divides the number of pixels in the cluster by the square of the known height (or width) of the token 205, which is shown in the equation below.

$$Pixels per Unit of Measurement = \frac{Number of Pixels in Cluster}{Known {Height}^{2}}$$

By way of example, in one embodiment, the computing device 100 determines that there are 16 pixels in the cluster of pixels (e.g., the token 205). If the known height of the token 205 is 2 centimeters and the known width of the token 205 is 2 centimeters, the computing device 100 squares the height (or width) of the token 205 to determine that the token 205 is 4 cm². Thus, the computing device 100 divides 16 pixels (the number of pixels in cluster) by 4 cm² (the known height²) to determine that there are approximately 4 pixels per square centimeter. A variety of other approaches and techniques may also be used.

In one embodiment, the computing device 100 can also determine the unit of measurement per pixel. For example, to determine the unit of measurement per pixel, the computing device 100 divides the known height (or width) of the token 205 by the number of pixels in the height of the cluster.

$$Unit of Measurement per Pixel = \frac{Known Height}{Number of Pixels High in Cluster}$$

By way of example, in one embodiment, the computing device 100 determines that there are 16 pixels in the cluster of pixels (e.g., estimating that the token 205 is approximately 4 pixels high and 4 pixels wide). Similarly, if the known height of the token 205 is 2 centimeters and the known width of the token 205 is 2 centimeters, the computing device 100 divides 2 centimeters (the known height of token 205) by 4 pixels (the number of pixels high in the cluster) to determine that the height of a pixel corresponds approximately to 0.5 centimeters in the image. In other words, each pixel has (a) a height that corresponds to approximately 0.5 cm in the image 200 and (b) a width that corresponds to approximately 0.5 cm in the image 200. A variety of other approaches and techniques may also be used.

Once the scale of the image 200 has been determined, the scale of the image 200 can be stored in association with the image 200. Furthermore, with the scale of the image 200, the computing device 100 can determine the size of any object in the image 200.

### 2. Deskewing the Cluster

In one embodiment, to determine the scale of the image 200, the computing device 100 first deskews the cluster of pixels (e.g., rights the token 205 in the image 200). For example, the computing device 100 (a) determines the skew of the cluster of pixels and (b) deskews the cluster of pixels. After the cluster of pixels has been deskewed, the computing device 100 determines the number of pixels on each dimension of the cluster of pixels e.g., determines how many (a) pixels comprise the height and (b) pixels comprise the width of the cluster. If the height and width dimensions are substantially similar (e.g., if the cluster is substantially four pixels high and substantially four pixels wide), the cluster is likely properly deskewed.

Additionally, in one embodiment, after determining the number of pixels on each dimension, the computing device 100 can determine the scale of the image 200. That is, the computing device can determine (a) the unit of measurement per pixel and/or (b) the number of pixels per unit of measurement in the image 200. By way of example, to determine the unit of measurement per pixel, the computing device 100 can divide the known height (or width) of the token 205 by the number of pixels in the height of the cluster.

$$Unit of Measurement per Pixel = \frac{Known Height}{Number of Pixels High in Cluster}$$

By way of example, in one embodiment, the computing device 100 determines that the deskewed cluster of pixels (e.g., the token 205) is approximately 4 pixels high and 4 pixels wide. With the known height of the token 205 being 2 centimeters, the computing device 100 divides 2 centimeters (the known height of token 205) by 4 pixels (the number of pixels high in the cluster) to determine that there are approximately 0.5 centimeters per pixel. In other words, each pixel has (a) a height that corresponds to approximately 0.5 cm in the image 200 and (b) a width that corresponds to approximately 0.5 cm in the image 200. A variety of other approaches and techniques may also be used.

In another embodiment, the computing device 100 can determine the pixels per unit of measurement. For example, to determine number of pixels per unit of measurement, the computing device 100 divides the number of pixels in the cluster by the square of the known height (or width) of the token 205, which is shown in the equation below.

$$Pixels per Unit of Measurement = \frac{Number of Pixels in Cluster}{Known {Height}^{2}}$$

By way of example, the computing device 100 determines that the deskewed cluster of pixels (e.g., the token 205) is approximately 4 pixels high and 4 pixels wide. Thus, the deskewed cluster of pixels has approximately 16 pixels in the cluster. Similarly, if the known height of the token 205 is 2 centimeters and the known width of the token 205 is 2 centimeters, the computing device 100 squares the height (or width) of the token 205 to determine that the token 205 is 4 cm². Further, the computing device 100 divides 16 pixels (the number of pixels in cluster)/4 cm² (the known height²) to determine that there are approximately 4 pixels per square centimeter. A variety of other approaches and techniques may also be used.

Once the scale of the image 200 has been determined, the scale of the image 200 can be stored in association with the image 200. Furthermore, with the scale of the image 200, the computing device 100 can determine the size of any object in the image 200.

d. Determining Object Sizes/Measurements

In one embodiment, after the scale of the image 200 has been determined, the computing device 100 can determine the size of any object in the image 200. For example, as shown in FIG. 3, a user (e.g., via a user interface) may graphically draw a line or identify two points in the image 200 to determine the approximate distance between the two points as it relates to the image 200. In one embodiment, this functionality can be used, for example, to determine the dimensions (e.g., size) of a wound (e.g., via the wound module 150). For instance, the computing device 100 can receive input identifying (a) a first point (e.g., receive input of a user clicking once to start a measurement) and (b) a second point (e.g., receive input of a user clicking twice to end the measurement). After receiving the input identifying the first point and the second point in the image 200, for example, the computing device 100 can display a line between the two points. In this example, the line between the first point and second point (shown in FIG. 3) corresponds to the width of the wound in the image 200.

After receiving the input identifying the first point and the second point in the image 200, the computing device 100 can determine the approximate distance between the first and second points. To do so, the computing device 100 can determine the number of pixels between the first point and second point, such as 20 pixels. With the scale of the image 200 stored in association with the image 200, the computing device 100 can then determine the approximate distance between the first and second points. Continuing with the above example, if there are 20 pixels between the first point and second point and each pixel corresponds to approximately 0.5 cm in the image 200, the computing device 100 can determine that the approximate measurement between the first and second points is 10 centimeters. Thus, in this example, the width of the wound is approximately 10 centimeters.

As discussed, in various embodiments, after the scale of the image 200 has been determined, the computing device 100 can determine the size/measurement of any object in the image 200. To accomplish such determinations of size/measurement, a variety of other approaches and techniques may also be used.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for determining the scale of an image, the computer-implemented method comprising:
receiving an image for analysis, wherein the image comprises a token with (a) a known height, (b) a known width, and (c) a known color value based on a color model;
identifying a predetermined threshold, wherein the predetermined threshold is used to identify a range of color values that have a substantially similar color value as the known color value of the token;
identifying a plurality of pixels in the image that are within the predetermined threshold;
identifying a cluster of pixels from the plurality of pixels, wherein the cluster of pixels substantially comprises the token; and
determining a scale of the image based at least in part on (a) the known height and the known width of the token and (b) the cluster of pixels.

2. The computer-implemented method of claim 1, wherein the shape of the token is substantially square.

3. The computer-implemented method of claim 2, wherein determining the scale of the image based at least in part on (a) the known height and the known width of the token and (b) the cluster of pixels comprises:
determining the number of pixels in the cluster of pixels; and
calculating the number of pixels per a unit of measurement in the cluster of pixels, wherein calculating the number of pixels per a unit of measurement in the cluster of pixels is determined by dividing (a) the number of pixels in the cluster of pixels by (b) the square of the known height.

4. The computer-implemented method of claim 1, wherein determining the scale of the image further comprises righting the image.

5. The computer-implemented method of claim 4, wherein righting the image further comprises:
determining a skew of the cluster of pixels from the plurality of pixels;
deskewing the cluster of pixels; and
determining the number of pixels in the cluster of pixels.

6. The computer-implemented method of claim 1, wherein each of the color values within the range of color values is within a Euclidean distance of a predetermined number from the known color value of the token.

7. The computer-implemented method of claim 1, wherein identifying the plurality of pixels in the image that are within the predetermined threshold is executed on the bit level of the image.

8. The computer-implemented method of claim 1, wherein the color model is the red, green, blue color model.

9. The computer-implemented method of claim 1 further comprising storing the scale of the image in association with the image.

10. The computer-implemented method of claim 9 further comprising:
receiving input identifying two points in the image; and
determining a measurement between the two points in the image based at least in part on the scale of the image.

11. The computer-implemented method of claim 10, wherein the two points in the image are selected from the group consisting of (a) a height of a wound in the image or (b) a width of a wound in the image.

12. A computer program product for determining the scale of an image, the computer program product comprising at least one computer-readable storage medium having computer-readable program code portions stored therein, the computer-readable program code portions comprising:
an executable portion configured to receive an image for analysis, wherein the image comprises a token with (a) a known height, (b) a known width, and (c) a known color value based on a color model;
an executable portion configured to identify a predetermined threshold, wherein the predetermined threshold is used to identify a range of color values that have a substantially similar color value as the known color value of the token;
an executable portion configured to identify a plurality of pixels in the image that are within the predetermined threshold;
an executable portion configured to identify a cluster of pixels from the plurality of pixels, wherein the cluster of pixels substantially comprises the token; and
an executable portion configured to determine a scale of the image based at least in part on (a) the known height and the known width of the token and (b) the cluster of pixels.

13. The computer program product of claim 12, wherein the shape of the token is substantially square.

14. The computer program product of claim 13, wherein the executable portion configured to determine the scale of the image based at least in part on (a) the known height and the known width of the token and (b) the cluster of pixels is further configured to:
determine the number of pixels in the cluster of pixels; and
calculate the number of pixels per a unit of measurement in the cluster of pixels, wherein calculating the number of pixels per a unit of measurement in the cluster of pixels is determined by dividing (a) the number of pixels in the cluster of pixels by (b) the square of the known height.

15. The computer program product of claim 12, wherein determining the scale of the image further comprises righting the image.

16. The computer program product of claim 15, wherein executable portion configured to determine the scale of the image and right the image is further configured to:
determine a skew of the cluster of pixels from the plurality of pixels;
deskew the cluster of pixels; and
determine the number of pixels in the cluster of pixels.

17. The computer program product of claim 12, wherein each of the color values within the range of color values is within a Euclidean distance of a predetermined number from the known color value of the token.

18. The computer program product of claim 12, wherein identifying the plurality of pixels in the image that are within the predetermined threshold is executed on the bit level of the image.

19. The computer program product of claim 12, wherein the color model is the red, green, blue color model.

20. The computer program product of claim 12 further comprising an executable portion configured to store the scale of the image in association with the image.

21. The computer program product of claim 20 further comprising:
an executable portion configured to receive input identifying two points in the image; and
an executable portion configured to determine a measurement between the two points in the image based at least in part on the scale of the image.

22. The computer program product of claim 21, wherein the two points in the image are selected from the group consisting of (a) a height of a wound in the image or (b) a width of a wound in the image.
